(19) United States
(12) Patent Application Publication
(10) Pub. No.: US 2021/0059493 A1
(43) Pub. Date: Mar. 4, 2021

(54) VACUUM CLEANER

(71) Applicant: TOSHIBA LIFESTYLE PRODUCTS & SERVICES CORPORATION, Kawasaki-shi (JP)

(72) Inventors: Kota WATANABE, Owariasahi (JP); Yuuki MARUTANI, Nagakute (JP)

(73) Assignee: TOSHIBA LIFESTYLE PRODUCTS & SERVICES CORPORATION, Kawasaki-shi (JP)

(21) Appl. No.: 16/605,072

(22) PCT Filed: May 22, 2018
(86) PCT No.: PCT/JP2018/019667

§ 371 Date: Oct. 14, 2019

(30) Foreign Application Priority Data
May 23, 2017 (JP) 2017-101948

(51) Int. Cl. A47L 9/28; G05D 1/02

(52) U.S. Cl. CPC A47L 9/2852; A47L 9/2805; G05D 1/0219; G05D 1/0246; A47L 2201/04; G05D 2201/0215; G05D 1/0274

(57) ABSTRACT

A vacuum cleaner includes a main casing, driving wheels, a cleaning unit, a memory, a sensor part and a communication part, a discriminating part, and a travel control part. The memory stores map data. The sensor part and the communication part acquire the information on a plurality of cleaning areas from an outside. The discriminating part discriminates the plurality of cleaning areas from the map data stored in the memory, on the basis of the information acquired by the sensor part and the communication part. The travel control part controls the driving of the driving wheels to make the main casing autonomously travel in each of the cleaning areas discriminated by the discriminating part. The vacuum can perform smart cleaning operation appealing to a user.

### TECHNICAL FIELD

Embodiments described herein relate generally to a vacuum cleaner capable of traveling autonomously.

### BACKGROUND ART

Conventionally, a so-called autonomously-traveling type vacuum cleaner (a cleaning robot) has been known, which cleans a floor surface as a cleaning-object surface while autonomously traveling on the floor surface.

A technique for performing efficient cleaning by such a vacuum cleaner is provided, by which map data is generated (through mapping) by reflecting the size and shape of a room to be cleaned, obstacles and the like, and thereafter an optimum traveling route is set on the basis of the generated map data so that the vacuum cleaner travels along the traveling route.

On the other hand, the generated map data includes the entire cleaning area, and is not suitable for recognition of individual rooms in the cleaning area. Therefore, the vacuum cleaner is likely to perform operation different from the normal cleaning operation by a cleaning person, in such a manner that the vacuum cleaner travels from one room to another room before the completion of the cleaning in one room, completes the cleaning in the another room, and returns to the one room and cleans the remaining area of the one room, as an example. As a result, the performance of the vacuum cleaner hardly appeals to a user.

### CITATION LIST

### Patent Literature

PTL 1: Japanese Laid-open Patent Publication No. 2012-96028

### SUMMARY OF INVENTION

### Technical Problem

The technical problem to be solved by the present invention is to provide a vacuum cleaner performing smart cleaning operation appealing to a user.

### Solution to Problem

A vacuum cleaner according to the embodiment has a main body, a travel driving part, a cleaning unit, a memory, an information acquisition part, a discriminating part, and a travel controller. The travel driving part allows the main body to travel. The cleaning unit performs cleaning. The memory stores map data. The information acquisition part acquires information on a plurality of cleaning areas from an outside. The discriminating part discriminates the plurality of cleaning areas from the map data stored in the memory, on the basis of the information acquired by the information acquisition part. The travel controller controls driving of the travel driving part to make the main body autonomously travel in each of the cleaning areas discriminated by the discriminating part.

### BRIEF DESCRIPTION OF DRAWINGS

FIG. 1 is a block diagram illustrating the internal structure of a vacuum cleaner according to one embodiment;

FIG. 2 is a perspective view illustrating the above vacuum cleaner;

FIG. 3 is a plan view illustrating the above vacuum cleaner as viewed from below;

FIG. 4 is an explanatory view schematically illustrating the method of calculating a three dimensional coordinate of an object by the above vacuum cleaner;

FIG. 5 is a perspective view illustrating an installation example of an identifier of the above vacuum cleaner;

FIG. 6(a) is an explanatory view illustrating one application of the above identifier, FIG. 6(b) is an explanatory view illustrating another application of the above identifier, FIG. 6(c) is an explanatory view illustrating further another application of the above identifier, FIG. 6(d) is an explanatory view illustrating further another application of the above identifier, and FIG. 6(e) is an explanatory view illustrating further another application of the above identifier;

FIG. 7 is an explanatory view schematically illustrating the information input through an external apparatus of the above vacuum cleaner; and

FIG. 8 is a flowchart partially indicating control of the above vacuum cleaner.

### DESCRIPTION OF EMBODIMENT

The configuration of one embodiment will be described below with reference to the drawings.

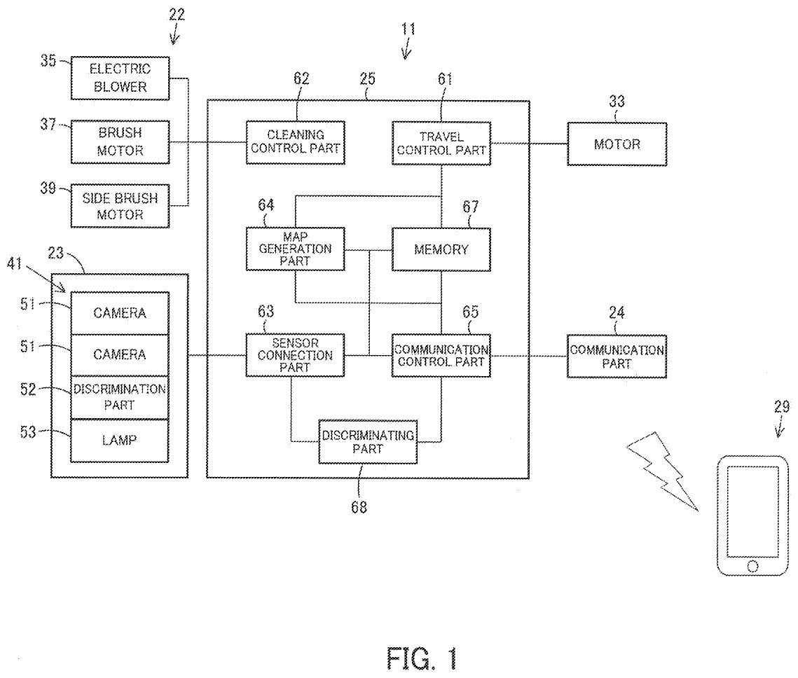

In FIG. 1 to FIG. 3, reference sign 11 denotes a vacuum cleaner. The vacuum cleaner 11 constitutes a vacuum cleaning apparatus (a vacuum cleaning system), serving as an autonomous traveler device, in combination with a charging device (a charging table) not shown, serving as a station device corresponding to a base station for charging the vacuum cleaner 11. Then, in the present embodiment, the vacuum cleaner 11 is a so-called self-propelled robot cleaner (a cleaning robot), which cleans a floor surface that is a cleaning-object surface as a traveling surface, while autonomously traveling (self-propelled) on the floor surface.

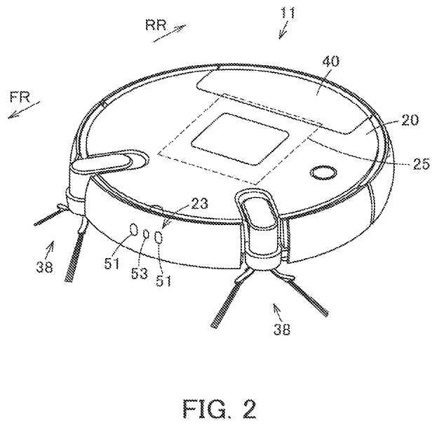

Then, the vacuum cleaner 11 includes a main casing 20 which is a hollow main body. The vacuum cleaner 11 further includes driving wheels 21, which is a travel driving part. The vacuum cleaner 11 further includes a cleaning unit 22 for removing dust and dirt. The vacuum cleaner 11 further includes a sensor part 23, serving as information acquisition means. The vacuum cleaner 11 further includes a communication part 24, which is communication means serving as information acquisition means for performing, for example, wired communication or wireless communication, via a network. The vacuum cleaner 11 further includes control means (a control part) 25, which is a controller. The vacuum cleaner 11 may further include a display part, serving as notification means. The vacuum cleaner 11 may further include a secondary battery, which is a battery for power supply. The vacuum cleaner 11 may further include an input/output part, which exchanges signals with an external apparatus 29 and/or a user. The external apparatus 29 is a general-purpose device, for example, a PC (a tablet terminal (a tablet PC)) or a smartphone (a mobile phone) corresponding to a mobile terminal, which is capable of, inside a building, performing wired or wireless communication with a network via, for example, a home gateway, and outside a building, performing wired or wireless communication with a network. The external apparatus 29 has a display function such as of a liquid crystal display for displaying an image. The external apparatus 29 further include an input function such as of a touch panel allowing a user to input operation. It is noted that the following description will be given on the basis that a direction extending along the traveling direction of the vacuum cleaner (the main casing 20) is treated as a back-and-forth direction (directions of an arrow FR and an arrow RR shown in FIG. 2), while a left-and-right direction (directions toward both sides) intersecting (orthogonally crossing) the back-and-forth direction is treated as a widthwise direction.

The main casing 20 is formed of, for example, synthetic resin. The main casing 20 may be formed into, for example, a flat column (a disk shape). The main casing 20 may further have a suction port 31 or the like which is a dust-collecting port, in the lower part or the like facing the floor surface.

The driving wheels 21 are used to make the vacuum cleaner 11 (the main casing 20) travel (autonomously travel) on the floor surface in the advancing direction and the backward direction, that is, serve for traveling use. In the present embodiment, the driving wheels 21 are disposed in a pair, for example, on the left and right sides of the main casing 20. The driving wheels 21 are driven by motors 33, serving as driving means. It is noted that a crawler or the like may be used as a travel driving part, instead of these driving wheels 21.

The motors 33 are disposed to correspond to the driving wheels 21. Accordingly, in the present embodiment, the motors 33 are disposed in a pair, for example, on the left and right sides. Then, the motors 33 are capable of independently and respectively driving the driving wheels 21.

The cleaning unit 22 is configured to remove dust and dirt existing on a cleaning-object part, for example, a floor surface or a wall surface or the like. In an example, the cleaning unit 22 has the function of collecting and catching dust and dirt existing on a floor surface through the suction port 31, and/or wiping a wall surface. The cleaning unit 22 may include at least one of an electric blower 35 for sucking dust and dirt together with air through the suction port 31, a rotary brush 36, serving as a rotary cleaner rotatably attached to the suction port 31 to scrape up dust and dirt and a brush motor 37 for rotationally driving the rotary brush 36, side brushes 38 which are auxiliary cleaning means (auxiliary cleaning parts), serving as swinging cleaning parts rotatably attached on the both sides of the main casing 20 on its front side or the like to scrape up dust and dirt and side brush motors 39 for driving the side brushes 38. The cleaning unit 22 may further include a dust-collecting unit 40 which communicates with the suction port 31 to accumulate dust and dirt.

The sensor part 23 is configured to sense various types of information which are used to support the traveling of the vacuum cleaner 11 (the main casing 20). More specifically, the sensor part 23 is configured to sense, for example, pits and bumps (a step gap) of a floor surface, a wall or an obstacle corresponding to a traveling obstacle, and an amount of dust and dirt on a floor surface. The sensor part 23 includes a periphery detection sensor 41. The sensor part 23 may further include, for example, an infrared sensor or a dust-and-dirt amount sensor (a dust sensor).

The periphery detection sensor 41 is configured to detect a shape in the periphery of the main casing 20. The periphery detection sensor 41 includes a camera 51, serving as image capturing means. The periphery detection sensor 41 further includes a discrimination part 52. It is noted that the periphery detection sensor 41 may include a lamp 53, serving as detection assisting means (a detection assisting part).

The camera 51 is a digital camera for capturing digital images having a specified horizontal angle of view (for example, 105 degrees) in the forward direction which is the traveling direction of the main casing 20, at specified time intervals, for example, at a micro-time basis such as several tens of milliseconds or the like, at a several-second basis or the like. The camera 51 may be configured with one camera, or with plural cameras. In the present embodiment, the cameras 51 are disposed in a pair on the left and right sides. That is, the cameras 51 are disposed apart from each other on the left side and the right side of the front portion of the main casing 20. Moreover, the cameras 51, 51 have image ranges (fields of view) overlapping with each other. Accordingly, the image regions of the images captured by these cameras 51, 51 overlap with each other in the left-and-right direction. It is noted that the camera 51 may capture, for example, a color image or a black/white image in a visible light region, or an infrared image.

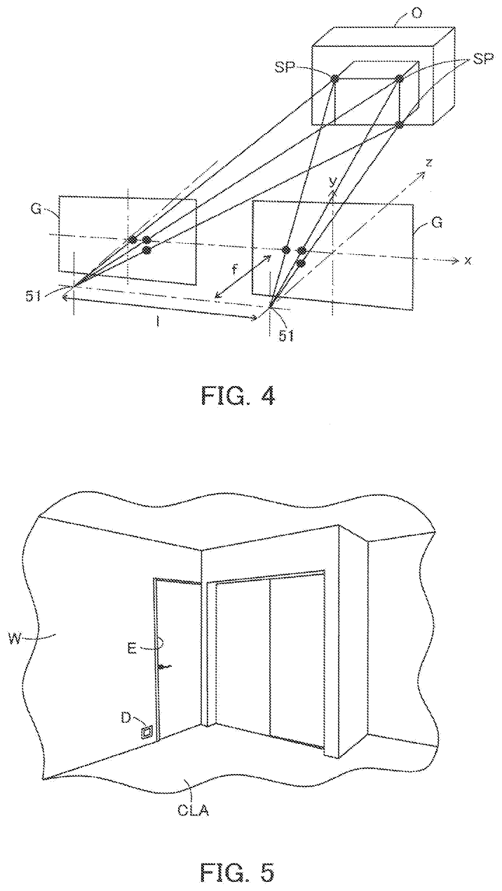

The discrimination part 52 is configured to detect the shape (distance, height and the like) of an object (such as an obstacle) positioned in the periphery of the main casing 20 from the images captured by the cameras 51, by extracting feature points and the like from the images captured by the cameras 51. In other words, the discrimination part 52 is configured to discriminate whether or not the object subjected to the calculation of the distance from the main casing 20 based on the images captured by the cameras 51 is an obstacle. In an example, the discrimination part 52 is configured to calculate the distance (depth) and three-dimensional coordinates of an object (feature points) by a known method, on the basis of the images captured by the cameras 51 and the distance between the cameras 51. More specifically, the discrimination part 52 is configured to apply triangulation based on a distance f (parallax) from the cameras 51, 51 to an object O (feature points SP) in images G, G captured by the cameras 51, 51 and a distance I between the cameras 51, 51, to detect pixel dots indicative of identical positions in the individual images G, G captured by the cameras 51, 51 and to calculate angles of the pixel dots in the up-and-down direction, the left-and-right direction and the back-and-forth direction, thereby calculating the heights and the distances of the positions from the cameras 51 on the basis of these angles and the distance I between the cameras 51, 51, and also calculating the three-dimensional coordinates of the object O (feature points SP) (FIG. 4). The discrimination part 52 is also configured to compare the distance of the object captured, for example, in a predetermined image range (for example, an image range set so as to correspond to the width and height of the main casing 20), with a set distance corresponding to a threshold value set previously or set variably, thereby discriminating that the object positioned at a distance (a distance from the vacuum cleaner 11 (the main casing 20)) identical to the set distance or closer is an obstacle. It is noted that the discrimination part 52 may include an image correction function of performing primary image processing to the original images captured by the cameras 51, for example, correction of distortion of the lenses, noise cancellation, contrast adjusting, and matching the centers of images. The discrimination part 52 may also be disposed in the control means 25. Further, in the case of the camera 51 configured with one camera, when the vacuum cleaner 11 (the main casing 20) moves, the discrimination part 52 is able to calculate the distance on the basis of the amounts of movement of the coordinates of an object.

The lamp 53 is configured to irradiate the image ranges of the cameras 51 to provide brightness required for image capturing. The lamp 53 is disposed so as to correspond to the cameras 51, as an example. For example, an LED light serves as the lamp 53.

The communication part 24 is a wireless LAN device, serving as wireless communication means (a wireless communication part) for performing wireless communication with the external apparatus 29 and as cleaner signal receiving means (a cleaner signal receiving part). The communication part 24 may have, for example, a web server function.

A microcomputer serves as the control means 25, and the microcomputer includes, for example, a CPU which is a control means main body (a control part main body), a ROM, a RAM and the like. The control means 25 includes a travel control part 61 which is travel control means for driving the driving wheels 21 (the motors 33). The control means 25 further includes a cleaning control part 62 which is cleaning control means electrically connected to the cleaning unit 22. The control means 25 further includes a sensor connection part 63, which is sensor control means electrically connected to the sensor part 23. The control means 25 further includes a map generation part 64, serving as mapping means (a mapping part). The control means 25 further includes a communication control part 65, which is communication control means electrically connected to the communication part 24. The control means 25 may further include a display control part, serving as display control means electrically connected to the display part. That is, the control means 25 is electrically connected to the cleaning unit 22, the sensor part 23, the communication part 24, the display part and the like. The control means 25 is further electrically connected to the secondary battery. Then, the control means 25 includes a memory 67, which is non-volatile storage means, for example, a flash memory. The control means 25 further includes a discriminating part 68, which is discriminating means. The control means 25 may further include a charging control part for controlling the charging of the secondary battery.

The travel control part 61 controls the driving of the motors 33. That is, the travel control part 61 controls a magnitude and a direction of the current flowing through each of the motors 33 to rotate each of the motors 33 in a normal or reverse direction, thereby controlling the driving of each of the motors 33. By controlling the driving of each of the motors 33, the travel control part 61 controls the driving of each of the driving wheels 21. The travel control part 61 may be configured to set the optimum traveling route on the basis of the map data generated by the map generation part 64 to be described below. As the optimum traveling route to be generated herein, a route which can provide efficient traveling (cleaning) is set, such as the route which can provide the shortest traveling distance for traveling in an area possible to be cleaned (an area excluding a part where traveling is impossible due to an obstacle, a step gap or the like) in the map data, for example, the route where the vacuum cleaner 11 (the main casing 20) travels straight as long as possible (where directional change is least required), the route where contact with an object as an obstacle is less, or the route where the number of times of redundantly traveling in the same location is the minimum, or the like. The travel control part 61 is also capable of changing the traveling route as needed, depending on the obstacle detected by the sensor part 23 (the periphery detection sensor 41 and the infrared sensor). The travel control part 61 is further capable of setting the traveling speed and the traveling route of the vacuum cleaner 11 (the main casing 20), on the basis of the remaining battery of the secondary battery. In an example, in the case where the remaining battery of the secondary battery is insufficient, the travel control part 61 may set the traveling speed of the vacuum cleaner 11 (the main casing 20) to a relatively-high speed, so that the vacuum cleaner 11 (the main casing 20) is able to clean a wider cleaning area in a short time.

The cleaning control part 62 controls the driving of the electric blower 35, the brush motor 37 and the side brush motors 39 of the cleaning unit 22. That is, the cleaning control part 62 individually controls the current-carrying quantities of the electric blower 35, the brush motor 37 and the side brush motors 39 individually and respectively, thereby controlling the driving of the electric blower 35, the brush motor 37 (the rotary brush 36) and the side brush motors 39 (the side brushes 38).

The sensor connection part 63 is configured to acquire the detection result obtained by the sensor part 23 (the periphery detection sensor 41, the infrared sensor, the dust-and-dirt amount sensor). The sensor connection part 63 may also include the function of a camera control part of controlling the operation (such as shutter operation) of the cameras 51 to make the cameras 51 capture images at specified time intervals and/or the function of an illumination control part of controlling the operation of the lamp 53 (such as on/off operation of the lamp 53).

The map generation part 64 is configured to generate the map data indicating whether or not the vacuum cleaner 11 is able to travel in the cleaning area on the basis of the shape (the distance and height of an object corresponding to an obstacle) in the periphery of the main casing 20 detected by the periphery detection sensor 41. Specifically, the map generation part 64 determines the self-position of the vacuum cleaner 11 and the presence/absence of an object corresponding to an obstacle, on the basis of the three-dimensional coordinates of the feature points of an object in the images captured by the cameras 51. The map generation part 64 further generates the map data indicating the positional relation and the heights of the objects (obstacles) and the like positioned in the cleaning area in which the vacuum cleaner 11 (the main casing 20) is positioned. That is, the map generation part is able to use the known technique of simultaneous localization and mapping (SLAM).

The communication control part 65 is configured to control the driving of the communication part 24, so that the communication part 24 exchanges information with the external apparatus 29 directly or via a network such as the Internet. The information to be exchanged between the communication part 24 and the external apparatus 29 is able to be set arbitrarily. In the present embodiment, the information preferably includes at least the information for identifying a cleaning area.

The memory 67 is able to store the map data generated by the map generation part 64, the map data received through the external apparatus 29 via the communication part 24, or the like.

The discriminating part 68 is capable of discriminating a plurality of cleaning areas (for example, a plurality of rooms) CLA, connecting areas (for example, a corridor) CNA each which connects the cleaning areas CLA or the like from the map data stored in the memory 67, on the basis of the information acquired from the sensor part 23 or the communication part 24. Specifically, the discriminating part 68 is capable of discriminating the plurality of cleaning areas (for example, a plurality of rooms) CLA, or the connecting areas (for example, a corridor) CNA each which connects the cleaning areas CLA or the like, on the basis of the information acquired via the sensor part 23 from an identifier D attached in a cleaning area or a connecting area, and the information input by a user via the communication part 24. It is noted that the discriminating part 68 may be provided integrally with the discrimination part 52.

For example, illumination means (an illumination part) such as an LED light for radiating light, or emission means (an emission part) for emitting ultrasonic waves, infrared rays or the like may serve as the identifier D. A sign in monochrome, for example, AR marker or QR code (registered mark), preferably serves as the identifier D, which is easily arranged and allows information to be identified by being captured by the cameras 51 of the sensor part 23 (the periphery detection sensor 41) and subjected to image processing. An item which is attachable and detachable in an easy manner, preferably a seal as an example, may be used as the identifier D. The identifier D is preferably attached to a position through which the vacuum cleaner 11 (the main casing 20) enters and exists from the cleaning area CLA. Preferably, the identifier D is further attached in a connecting area (for example, a corridor) which connects cleaning areas different from each other. Preferably, the identifier D is attached on, for example, a wall surface W in the vicinity of an entrance E through which the vacuum cleaner 11 (the main casing 20) enters and exits from a target room, especially on a lower portion of the wall surface W (FIG. 5).

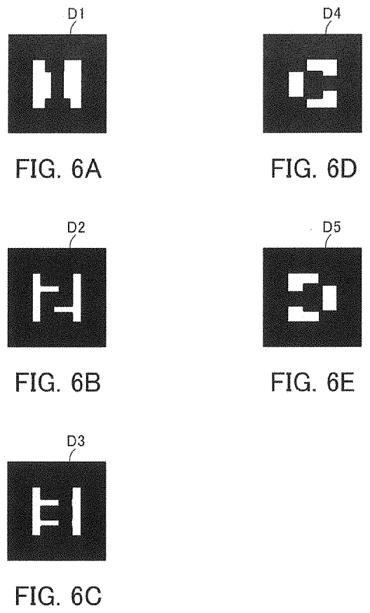

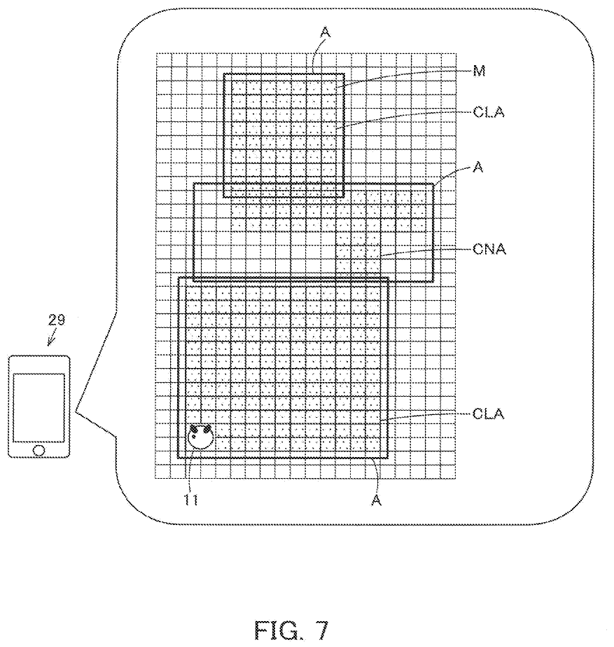

FIG. 6(a) to FIG. 6(e) respectively show the examples of the identifiers D. An identifier D1, an identifier D2 and an identifier D3 respectively shown in FIG. 6(a) to FIG. 6(c) are the AR markers indicating, for example, the area numbers (1 to 3) of the cleaning areas for identifying the cleaning areas. These numbers may be used as the information (ID) for simply identifying the cleaning areas, or may be used as the numbers indicating the order of cleaning in the cleaning areas. FIG. 6(d) and FIG. 6(e) respectively show the AR markers each indicating the direction toward an entrance to a target cleaning area (a room), as an example. For example, an identifier D4 shown in FIG. 6(d) is the AR marker which imitates the arrow toward the right direction to indicate that a target entrance is positioned in the right of the identifier D4, while an identifier D5 shown in FIG. 6(e) is the AR marker which imitates the arrow toward the left direction to indicate that a target entrance is positioned in the left of the identifier D5.

In the case where such an AR marker is used as an identifier, any figure is available, as long as the figure allows information to be identified by being captured by the cameras 51 (FIG. 1) and subjected to image processing. Accordingly, such a figure allowing a user to intuitively understand the information indicated by the identifier is preferably used, like the identifiers D1 to D5 as described above. Alternatively, in the case where an identifier and the object whose information is indicated by the identifier are kept in a fixed relation, for example, the case where an identifier is able to be attached so as to constantly have a predetermined positional relation with respect to the entrance to a target cleaning area (for example, the case where an identifier is always attached on a lower left portion of a wall surface with respect to the entrance), simply the presence/absence of an identifier may indicate such information, instead of a figure of an identifier. In the case where a cleaning area has a plurality of entrances, identifiers may be attached to the vicinities of the respective entrances.

Also, the information input by a user via the external apparatus 29 corresponds to the information on the areas of the cleaning areas CLA and the connecting areas CNA, which are enclosed and specified by the user as areas A each including the cleaning area CLA or the connecting area CNA from map data M stored in the memory 67 (FIG. 1) of the vacuum cleaner 11 and transmitted to the external apparatus 29 via the communication part 24 (FIG. 1), and the information on the order of traveling (cleaning) in the cleaning areas CLA specified by the user by sequentially tapping of the enclosed areas A (FIG. 7). In this case, all of the cleaning areas CLA and the connecting areas CNA may be enclosed and specified one by one. Alternatively, only the areas of the cleaning areas CLA may be enclosed, whereby the areas not enclosed in any of the cleaning areas CLA of the map data M may be set as the connecting areas CNA.

It is noted that in the case where the map data is not stored in the memory 67 (FIG. 1), an instruction to generate the map data may be issued to the vacuum cleaner 11. Alternatively, a user may appropriately use the grids displayed in the external apparatus 29 by application and the like to generate a map for each grid, or may specify the traveling start position (cleaning start position) of the vacuum cleaner 11 (the main casing 20). Preferably, the areas of the cleaning areas and the connecting areas and the order of traveling (the order of cleaning) therein set as described above are transmitted to the vacuum cleaner 11, received by the communication part 24, and stored so as to be associated with the map data in the memory 67.

In summary, as for creation of the map data, discrimination of the cleaning areas, and the ordering of traveling (the order of cleaning) in the cleaning areas, the vacuum cleaner 11 may perform these types of operation independently via the sensor part 23 (the periphery detection sensor 41) during the autonomous traveling, or a user may input these types of information through the external apparatus 29 so that the vacuum cleaner 11 receives them via the communication part 24. Alternatively, the detection by the sensor part 23 (the periphery detection sensor 41) and the reception via the communication part 24 of the input through the external apparatus 29 may be combined arbitrarily. In an example, the vacuum cleaner 11 independently performs at least one of the creation of the map data, the discrimination of the cleaning areas, and the ordering of traveling (the order of cleaning) in the cleaning areas, via the sensor part 23 (the peripheral detection sensor 41) during the autonomous traveling, while a user inputs other remaining types of information through the external apparatus 29 so that the vacuum cleaner 11 receives them via the communication part 24.

It is noted that in the description of the present embodiment, the travel control part 61, the cleaning control part 62, the sensor connection part 63, the map generation part 64, the communication control part 65, the display control part, the memory 67 and the discriminating part 68 shown in FIG. 1 are integrally provided in the control means 25. Alternatively, these parts may be provided individually, or at least some of them may be combined arbitrarily and provided integrally.

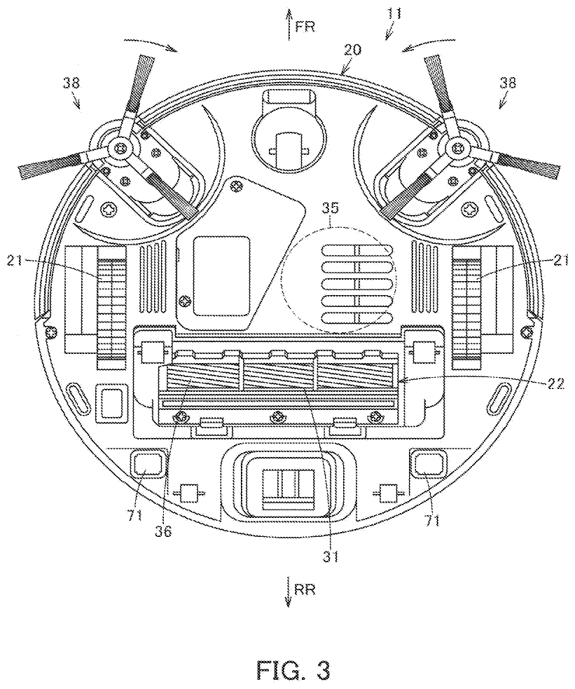

The secondary battery is configured to supply electric power to the cleaning unit 22, the sensor part 23, the communication part 24, the control means 25, the display part and the like. The secondary battery is electrically connected to charging terminals 71 (FIG. 3), which serve as connection parts and are exposed and disposed at the lower portions of the main casing 20, as an example. The secondary battery is configured to be charged via the charging device when the charging terminals 71 (FIG. 3) are electrically and mechanically connected to the charging device side.

The charging device incorporates a charging circuit, for example, a constant current circuit. The charging device includes terminals for charging to be used to charge the secondary battery. The terminals for charging are electrically connected to the charging circuit. The terminals for charging are configured to be mechanically and electrically connected to the charging terminals 71 (FIG. 3) of the vacuum cleaner 11 returning to the charging device.

The operation of the above-described embodiment is described below.

In general, the work of the vacuum cleaning apparatus is roughly divided into cleaning work for carrying out cleaning by the vacuum cleaner 11, and charging work for charging the secondary battery with the charging device. The charging work is implemented by a known method using the charging circuit incorporated in the charging device. Accordingly, only the cleaning work will be described. Also, image capturing work for capturing images of a specified object by the cameras 51 in response to an instruction issued by the external apparatus or the like may be included separately.

The outline from the start to the end of the cleaning is described first. In the case where the map data is not stored in the memory 67, in order to start the cleaning, the vacuum cleaner 11 may independently generate the map and store the map in the memory 67, or may wait for the map data to be input through the external apparatus 29 or the like and stored in the memory 67, and thereafter may start the cleaning. Thereafter, the discriminating part 68 discriminates cleaning areas (rooms) and connecting areas (corridor) from the map data stored in the memory 67, on the basis of the information acquired via the communication part 24 or the information acquired by the sensor part 23 (the periphery detection sensor 41), and the vacuum cleaner 11 autonomously travels in each of the discriminated rooms to perform the cleaning, sequentially. That is, after finishing the cleaning in one cleaning area, the vacuum cleaner 11 performs the cleaning in the next cleaning area. When finishing the cleaning in all of the cleaning areas, the vacuum cleaner 11 returns to the charging device, and thereafter shifts to the charging work for charging the secondary battery.

The above control is described below more specifically. In the vacuum cleaner 11, the control means 25 is switched over from a standby mode to a traveling mode (a cleaning mode), at timing such as when a preset cleaning start time arrives, when the input/output part receives the control command to start the cleaning transmitted by a remote control or the external apparatus 29, or when power is supplied. Thereafter, in the case where the map data including the entire cleaning areas is not stored in the memory 67, in the vacuum cleaner 11, a user inputs the map data through the external apparatus 29, or alternatively the map generation part 64 generates the map on the basis of the information on the periphery of the vacuum cleaner 11 (the main casing 20) acquired by the sensor part 23 (the periphery detection sensor 41), while the travel control part 61 controls the driving of the driving wheels (the motors 33) to make the main casing 20 travel autonomously. At this time, in the vacuum cleaner 11, the discriminating part 68 is able to discriminate the cleaning areas on the basis of the information input by a user through the external apparatus 29 or the acquired information for identifying the cleaning areas on the basis of the identifiers set in the respective cleaning areas.

In the case where the map data including the entire cleaning areas is stored in the memory 67, and where the cleaning is to be started from the position of the charging device, the travel control part 61 controls the driving of the driving wheels 21 (the motors 33) to undock the vacuum cleaner 11 (the main casing 20) from the charging device. In turn, in the case where the cleaning is to be started from a position different from the charging device, the discriminating part 68 collates the information on the periphery of the vacuum cleaner 11 (the main casing 20) acquired by the sensor part 23 (the periphery detection sensor 41) or the information input by a user through the external apparatus 29 and received via the communication part 24, with the information registered in the map data stored in the memory 67, and identifies the cleaning area (room) in which the vacuum cleaner 11 (the main casing 20) is positioned currently and the position of the vacuum cleaner 11 (the main casing 20) in the cleaning area. Thereafter, in the vacuum cleaner 11, the discriminating part 68 discriminates the cleaning areas. At the time of the discrimination, for example, the information on the respective cleaning areas (for example, IDs of the cleaning areas such as the numbers indicating the order of cleaning in the cleaning areas) registered in the map data stored in the memory 67 may be used as they are. Alternatively, new information may be registered and the newly-registered information may be used. In an example, a user may input new information through the external apparatus 29, and the new information may be received and acquired via the communication part 24. Alternatively, the new information may be acquired via the sensor part 23 (the periphery detection sensor 41) from the identifiers, while the travel control part 61 makes the vacuum cleaner 11 (the main casing 20) autonomously travel in the cleaning areas.

The order of the discriminated cleaning areas in which the travel control part 61 makes the vacuum cleaner 11 (the main casing 20) travel autonomously, that is, the order of cleaning in the cleaning areas is set. The numbers included in the information on the cleaning areas (the numbers set by the external apparatus 29 or the numbers read from the identifiers) may be used for the setting, or the travel control part 61 may automatically set the numbers. In the automatic setting, in an example, the numbers may be set so that the vacuum cleaner 11 (the main casing 20) travels (performs the cleaning) in a sequential manner from the cleaning area in which the vacuum cleaner 11 (the main casing 20) is positioned currently to an adjacent cleaning area, or the numbers may be set by referring to all of the cleaning areas, so that the vacuum cleaner 11 (the main casing 20) is able to travel (perform the cleaning) in the most efficient manner. Similarly, the cleaning area not allowing the vacuum cleaner (the main casing 20) to travel may be set, that is, the cleaning area not subjected to the cleaning may be set.

Thereafter, the travel control part 61 sets the traveling route on the basis of the plurality of cleaning areas identified from the map data as cleaning objects or the connecting areas each connecting these cleaning areas. The traveling route is set, for example, for each identified cleaning area or each identified connecting area.

Then, the cleaning control part 62 operates the cleaning unit 22 to clean the floor surfaces in the cleaning areas or the floor surfaces in the connecting areas, while the travel control part 61 controls the driving of the driving wheels (the motors 33) to make the main casing 20 autonomously travel along the set traveling route. For example, the electric blower 35, the brush motor 37 (the rotary brush 36) or the side brush motors 39 (the side brushes 38) of the cleaning unit 22 driven by the control means 25 (the cleaning control part 62) catches and collects dust and dirt on the floor surfaces through the suction port 31 in the dust-collecting unit 40. When the periphery detection sensor 41 or the infrared sensor of the sensor part 23 detects the three-dimensional coordinates or the position of an object such as an obstacle not stored in the map data during when the vacuum cleaner 11 travels autonomously, the map generation part 64 is also able to reflect the detection in the map data, and the memory 67 is able to store the map data.

After the completion of the traveling and the cleaning along the traveling route set in one cleaning area which is a cleaning object, the vacuum cleaner 11 (the main casing 20) moves to another cleaning area which is the next cleaning object, and performs the cleaning while traveling along the traveling route set in the cleaning area. As for these traveling routes, when the vacuum cleaner 11 (the main casing 20) moves to the next cleaning area, the traveling route for the next cleaning area may be set. Alternatively, the traveling route may be set in advance for each of all the cleaning areas or for each of all the connecting areas at the timing of cleaning start. In the case where the entrance to the cleaning area to be cleaned is closed by a door or the like for closing and opening the entrance, as an example, the travel control part 61 may control the driving of the driving wheels 21 (the motors 33) to make the vacuum cleaner 11 move to another cleaning area which is the next cleaning object, by skipping the order in the cleaning area.

After traveling along the traveling routes set in all of the cleaning areas which are the cleaning objects, the vacuum cleaner 11 finishes the cleaning operation. The travel control part 61 controls the driving of the driving wheels (the motors 33) to make the vacuum cleaner 11 return to the charging device so that the vacuum cleaner 11 is connected to the charging device (so that the charging terminals 71 and the terminals for charging are connected mechanically and electrically). Thereafter, the vacuum cleaner 11 is able to shift to charging operation at predetermined timing, such as just after the connection, or when a predetermined period of time elapses after the connection.

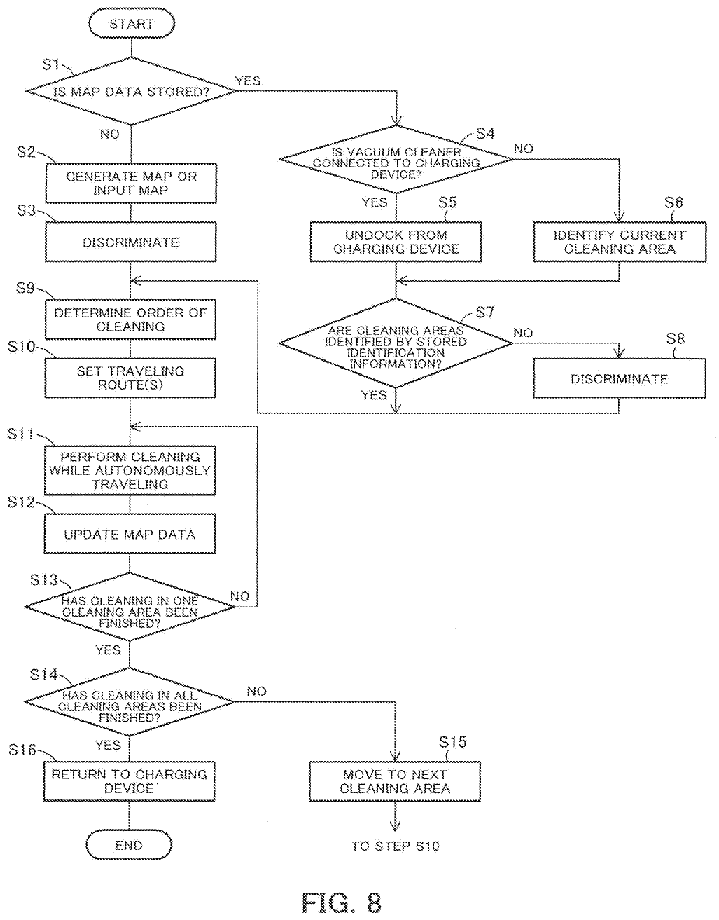

One example of the above control is described below with reference to the flowchart indicated in FIG. 8.

When the cleaning is started, firstly, the vacuum cleaner 11 determines whether or not the map data is stored in the memory 67 (step S1). In the case where the vacuum cleaner 11 determines that the map data is not stored in the memory 67 in step S1, a user inputs the map data through the external apparatus 29, or the map generation part 64 generates the map while the travel control part 61 controls the driving of the driving wheels 21 (the motors 33) to make the vacuum cleaner 11 (the main casing 20) autonomously travel in all of the cleaning areas (step S2). In the vacuum cleaner 11, the discriminating part 68 discriminates the cleaning areas from the map data, on the basis of the information input by the user through the external apparatus 29 and received via the communication part 24, or the information acquired by the sensor part 23 (the periphery detection sensor 41) via the identifiers D (step S3), and the processing proceeds to step S9.

In the case where the vacuum cleaner 11 determines that the map data is stored in the memory 67 in step S1, whether or not the vacuum cleaner 11 is connected to the charging device is determined (step S4). In the case where it is determined that the vacuum cleaner 11 is connected to the charging device in step S4, the travel control part 61 controls the driving of the driving wheels 21 (the motors 33) to make the vacuum cleaner 11 (the main casing 20) undock from the charging device (step S5), and the processing proceeds to step S7. In the case where it is determined that the vacuum cleaner 11 is not connected to the charging device in step S4, the cleaning area in which the vacuum cleaner 11 (the main casing 20) is positioned currently is identified (step S6), and the processing proceeds to step S7.

The determination is made, of whether or not the discriminating part 68 discriminates the cleaning areas by use of the identification information on the respective cleaning areas included in the map data stored in the memory 67 (step S7). In the case where it is determined in step S7 that the identification information on the respective cleaning areas included in the map data is used for discrimination, the processing proceeds to step S9 as it is. In the case where it is determined that the identification information on the respective cleaning areas included in the map data is not used for discrimination, the discriminating part 68 discriminates the cleaning areas on the basis of the information input by a user through the external apparatus and received via the communication part 24, or the information acquired by the sensor part 23 (the periphery detection sensor 41) via the identifiers (step S8), and the processing proceeds to step S9.

Thereafter, the travel control part 61 determines the order in which the vacuum cleaner 11 (the main casing 20) is made to autonomously travel in the cleaning areas, that is, the order of cleaning in the cleaning areas (step S9).

The travel control part 61 further sets the traveling route (s) of the vacuum cleaner 11 (the main casing 20) in the cleaning areas (step S10). In this case, the travel control part 61 may set, each time the vacuum cleaner 11 moves to another cleaning area, the traveling route for the cleaning area, or may set the traveling routes at once respectively for all of the cleaning areas.

Along the traveling routes set in step S10, the travel control part 61 controls the driving of the driving wheels (the motors 33) to make the vacuum cleaner 11 (the main casing 20) travel autonomously, and the cleaning control part 62 operates the cleaning unit 22 to perform the cleaning (step S11). Also, the vacuum cleaner 11 (the main casing 20) acquires the information on the periphery thereof via the sensor part 23 (the periphery detection sensor 41) during the autonomous traveling, and updates the map data stored in the memory 67 whenever necessary (step S12), and thereafter the processing may proceed to step S13.

Thereafter, the travel control part 61 determines whether or not the vacuum cleaner 11 (the main casing 20) has finished the traveling along the traveling route in the one cleaning area in which the vacuum cleaner 11 (the main casing 20) is positioned currently, in other words, whether or not the vacuum cleaner 11 (the main casing 20) has finished the cleaning in the cleaning area (step S13). In the case where, in step S13, the travel control part 61 determines that the vacuum cleaner 11 (the main casing 20) has not finished the traveling (has not finished the cleaning) along the traveling route, the processing proceeds to step S11. In the case where, in step S13, the travel control part 61 determines that the vacuum cleaner 11 (the main casing 20) has finished the traveling (has finished the cleaning) along the traveling route, the travel control part 61 determines whether or not the vacuum cleaner 11 (the main casing 20) has finished the traveling in all of the cleaning areas, that is, whether or not the vacuum cleaner 11 (the main casing 20) has finished the cleaning in all of the cleaning areas (step S14).

In the case where, in step S14, the travel control part 61 determines that the vacuum cleaner 11 (the main casing 20) has not finished the traveling in all of the cleaning areas (has not finished the cleaning in all of the cleaning areas), the travel control part 61 controls the driving of the driving wheels 21 (the motors 33) to make the vacuum cleaner 11 (the main casing 20) travel to another cleaning area of the next order of cleaning (step S15) according to the order of cleaning determined in step S9, and the processing proceeds to step S10. It is noted that in the case where the traveling route for each of all the cleaning areas is set in step S10, the processing may proceed from step S15 to step S11.

In the case where, in step S14, the travel control part 61 determines that the vacuum cleaner 11 (the main casing 20) has finished the traveling in all of the cleaning areas (has finished the cleaning in all of the cleaning areas), the travel control part 61 controls the driving of the driving wheels (the motors 33) to make the vacuum cleaner 11 (the main casing 20) autonomously travel and return to the charging device (step S16), and thereafter the cleaning control is finished.

In the case where there are a plurality of cleaning areas (rooms) and where the cleaning areas such as rooms are not separately discriminated during when the cleaning unit 22 performs the cleaning while the vacuum cleaner 11 (the main casing 20) autonomously travels in the cleaning areas by use of the map data as described above, the travel control part 61 may possibly make the vacuum cleaner 11 (the main casing 20) travel to another cleaning area before finishing the cleaning in one cleaning area. The image recognition or the like by use of the sensor part 23 (the periphery detection sensor 41) possibly enables the discrimination of the cleaning areas, by recognizing a door for an entrance to a cleaning area, or recognizing a certain spatial spread. On the other hand, it is not easy for the cameras 51 of the vacuum cleaner 11 traveling on a floor surface to capture images of the whole door, and a cleaning area includes some narrow parts. Accordingly, with respect to spatial recognition, there is a high probability of erroneous detection unless a ceiling camera and the like is disposed.

In the present embodiment which includes the sensor part (the periphery detection sensor 41) and/or the communication part 24 for acquiring the information on the plurality of cleaning areas from the outside, the discriminating part 68 discriminates the plurality of cleaning areas from the map data stored in the memory 67, on the basis of the acquired information on the plurality of cleaning areas, and the travel control part 61 makes the vacuum cleaner 11 (the main casing 20) autonomously travel in each of the cleaning areas. The above operation enables to ensure the cleaning in one cleaning area, and thereafter to make the vacuum cleaner 11 move to another cleaning area. Accordingly, the vacuum cleaner 11 autonomously performs the cleaning operation in each cleaning area similar to the normal cleaning operation by a cleaning person, whereby such smart cleaning operation appeals to a user.

Also, the information on the cleaning areas acquired by the sensor part 23 (the periphery detection sensor 41) and/or the communication part 24 includes the information for identifying the cleaning areas, thereby enabling to set the cleaning areas to be cleaned automatically or manually.

The discriminating part 68 further discriminates the cleaning area (room) in which the vacuum cleaner 11 (the main casing 20) is positioned currently, on the basis of the information on the cleaning areas acquired by the sensor part (the periphery detection sensor 41) and/or the communication part 24, thereby allowing the vacuum cleaner 11 to grasp the self-position without losing the self-position, and further enabling to make the vacuum cleaner 11 smoothly return to the charging device after the completion of the cleaning, even in the case where the vacuum cleaner 11 does not start the autonomous traveling (cleaning) from the position of the charging device, and is carried to another cleaning area to start the autonomous traveling (cleaning) therefrom.

In the case where the travel control part 61 sets the order in the cleaning areas where the vacuum cleaner 11 (the main casing 20) is made to travel autonomously, on the basis of the order in the cleaning areas included in the information acquired by the sensor part 23 (the periphery detection sensor 41) and/or the communication part 24, a user is able to surely and easily set the order in the cleaning areas by arranging the identifiers and/or performing input through the external apparatus 29.

Alternatively, in the case where the travel control part 61 automatically sets the order in the cleaning areas where the vacuum cleaner 11 (the main casing 20) is made to travel autonomously, in the cleaning areas identified on the basis of the information acquired by the sensor part 23 (the periphery detection sensor 41) and/or the communication part 24, a user is not required to arrange the identifiers and/or perform the input through the external apparatus 29, with respect to the order of cleaning in the cleaning areas, thereby enabling to improve usability.

Further, the travel control part 61 sets the cleaning area in which the vacuum cleaner 11 (the main casing 20) is made not to travel, in the cleaning areas identified on the basis of the information acquired by the sensor part 23 (the periphery detection sensor 41) and/or the communication part 24, thereby enabling to easily exclude the cleaning area not to be cleaned from the cleaning objects.

Also, the information transmitted through the external apparatus 29 is received via the communication part 24, whereby the vacuum cleaner 11 acquires the information on the peripheral cleaning areas. Accordingly, a user is able to directly input the information on the cleaning areas into the vacuum cleaner 11 through the external apparatus 29. A user is able to easily set the information on the cleaning areas by use of the external apparatus 29 especially in the case of a mobile terminal such as a smartphone previously including a display function, an input function and a communication function, merely by using the application enabling to display the map data stored in the memory 67 of the vacuum cleaner 11, to create the map data, and to specify the ranges of the cleaning areas in the map data.

Further, the sensor part 23 (the periphery detection sensor 41) acquires the information on the cleaning areas from the identifiers attached in the cleaning areas. Therefore, a user merely attaches the identifiers in the cleaning areas, whereby the discriminating part 68 of the vacuum cleaner 11 is able to discriminate the cleaning areas automatically.

Also, the identifiers are attached to the positions in the cleaning areas (rooms), through which the vacuum cleaner 11 (the main casing 20) enters and exists from the cleaning areas (rooms), thereby enabling to clearly notify the vacuum cleaner 11 of the information that the areas forward from the positions at which the identifiers are arranged are not the cleaning areas. Accordingly, the vacuum cleaner 11 is able to effectively discriminate the cleaning areas.

Further, as for the order of cleaning in the cleaning areas to be cleaned, for example, AR markers corresponding to the order may be used as identifiers, and a user may attach the AR markers to the cleaning areas in the order. In this case, the vacuum cleaner 11 performs the operation to check the numbers registered in the map at the time of cleaning start, or the information acquired by the sensor part 23 (the periphery detection sensor 41) from the identifiers, thereby enabling to easily realize the numbering.

Also, in the case where there is a connecting area (such as a corridor) which connects cleaning areas, the identifier is attached to the vicinity of the entrance to a target cleaning area in the connecting area, thereby enabling to recognize the connecting area as a cleaning area and to distinguish the connecting area and the cleaning area. Accordingly, the cleaning is able to be performed without confusion with respect to the connecting area and the adjacent cleaning area, and the cleaning is able to be separately performed also in the connecting area.

Further, the identifiers are configured to be freely detachable/attachable by a user, thereby allowing a user to set the cleaning areas at will.

It is noted that the above-described embodiment includes at least one of the sensor part 23 (the periphery detection sensor 41) and the communication part 24.

The vacuum cleaner 11 may be configured without the map generation part 64, as long as the vacuum cleaner 11 is configured to receive the map data from the external apparatus 29 via the communication part 24, as an example.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

(1) A travel control method for a vacuum cleaner, the travel control method including the steps of acquiring information on a plurality of cleaning areas from an outside, discriminating the plurality of cleaning areas from map data stored in a memory on a basis of the acquired information, and making a main body autonomously travel in each of the discriminated cleaning areas.

(2) The travel control method for the vacuum cleaner according to (1), wherein the information on each of the cleaning areas to be acquired includes information for identifying each of the cleaning areas.

(3) The travel control method for the vacuum cleaner according to (2), the travel control method including the step of discriminating a cleaning area of the main body positioned currently on the basis of the acquired information.

(4) The travel control method for the vacuum cleaner according to (2) or (3), the travel control method including the step of setting an order of traveling in the cleaning areas to make the main body travel, on a basis of an order in the cleaning areas included in the acquired information.

(5) The travel control method for the vacuum cleaner according to (2) or (3), the travel control method including the step of setting an order of traveling in the cleaning areas to make the main body travel, in the cleaning areas identified on the basis of the acquired information.

(6) The travel control method for the vacuum cleaner according to any one of (1) to (5), the travel control method including the step of setting a cleaning area not allowing the main body to travel in the cleaning areas identified on the basis of the acquired information.

(7) The travel control method for the vacuum cleaner according to any one of (1) to (6), the travel control method including the step of acquiring the information on the plurality of cleaning areas by communication with an external apparatus.

(8) The travel control method for the vacuum cleaner according to (7), the travel control method including the step of acquiring the information on the plurality of cleaning areas by communication with a mobile terminal.

(9) The travel control method for the vacuum cleaner according to any one of (1) to (8), the travel control method including the step of acquiring, from an identifier attached in a cleaning area, the information on the cleaning area.

(10) The travel control method for the vacuum cleaner according to (9), wherein the main body enters and exits from the cleaning area through an entrance position, and the identifier is attached to the entrance position.

(11) The travel control method for the vacuum cleaner according to (10), wherein the identifier is further attached in a connecting area connecting cleaning areas different from each other.

(12) The travel control method for the vacuum cleaner according to any one of (9) to (11), wherein the identifier is attachable and detachable.

1. A vacuum cleaner comprising:
a main body;
a travel driving part configured to allow the main body to travel;
a cleaning unit configured to perform cleaning;
a memory configured to store map data;
an information acquisition part configured to acquire information on a plurality of cleaning areas from an outside;
a discriminating part configured to discriminate the plurality of cleaning areas from the map data stored in the memory, on a basis of the information acquired by the information acquisition part; and
a travel controller configured to control driving of the travel driving part to make the main body autonomously travel in each of the cleaning areas discriminated by the discriminating part.

2. The vacuum cleaner according to claim 1, wherein
the information on each of the plurality of cleaning areas acquired by the information acquisition part includes information for identifying each of the cleaning areas.

3. The vacuum cleaner according to claim 2, wherein
the discriminating part discriminates a cleaning area of the main body positioned currently, on the basis of the information acquired by the information acquisition part.

4. The vacuum cleaner according to claim 2, wherein
the travel controller sets an order of traveling in the cleaning areas to make the main body travel, on a basis of an order in the cleaning areas included in the information acquired by the information acquisition part.

5. The vacuum cleaner according to claim 2, wherein
the travel control part sets an order of traveling in the cleaning areas to make the main body travel, in the cleaning areas identified on the basis of the information acquired by the information acquisition part.

6. The vacuum cleaner according to claim 1, wherein
the travel controller sets a cleaning area not allowing the main body to travel in the cleaning areas identified on the basis of the information acquired by the information acquisition part.

7. The vacuum cleaner according to claim 1, wherein
the information acquisition part is a communication part configured to communicate with an external apparatus.

8. The vacuum cleaner according to claim 7, wherein
the external apparatus is a mobile terminal.

9. The vacuum cleaner according to claim 1, wherein
the information acquisition part acquires, from an identifier attached in a cleaning area, the information on the cleaning area.

10. The vacuum cleaner according to claim 9, wherein
the main body enters and exits from the cleaning area through an entrance position, and the identifier is attached to the entrance position.

11. The vacuum cleaner according to claim 10, wherein
the identifier is further attached in a connecting area connecting cleaning areas different from each other.

12. The vacuum cleaner according to claim 9, wherein
the identifier is attachable and detachable.
